(19) United States
(12) Patent Application Publication
(10) Pub. No.: US 2010/0281146 A1
(43) Pub. Date: Nov. 4, 2010

(54) DYNAMIC DOMAIN NAME SERVICE SYSTEM AND AUTOMATIC REGISTRATION METHOD

(75) Inventor: Jung Jen Lee, Taipei County (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: VIVOTEK INC., Taipei County (TW)

(21) Appl. No.: 12/770,076

(22) Filed: Apr. 29, 2010

(30) Foreign Application Priority Data
Apr. 30, 2009 (TW) 098114458

(51) Int. Cl. G06F 15/177

(52) U.S. Cl. 709/221

(57) ABSTRACT

A dynamic domain name service (DDNS) system and an automatic registration method are described. The system includes a network device and a dynamic domain name server (DNS). The method includes the following steps. Account information is input through a user interface of the network device. The network device is connected to a corresponding dynamic DNS through Internet according to the account information and is registered. The registered network device continuously updates an IP address automatically for the dynamic DNS.

### CROSS-REFERENCE TO RELATED APPLICATIONS

This non-provisional application claims priority under 35 U.S.C. §119(a) on Patent Application No(s). 098114458 filed in Taiwan, R.O.C. on Apr. 30, 2009, the entire contents of which are hereby incorporated by reference.

### BACKGROUND OF THE INVENTION

1. Field of the Invention

The present invention relates to a dynamic domain name service (DDNS) system and an automatic registration method, and more particularly to a DDNS system and an automatic registration method, which are applicable to the Internet.

2. Related Art

The Internet Protocol (IP) refers to a communication protocol used when digital signals are circulated on the Internet. The IP address refers to an address of a computer host on the Internet. Taking an IP version 4 (IPv4) as an example, an IPv4 address is represented by four groups of numbers. Each of the four groups of numbers is between 0 and 255. Basically, each computer host connected to the Internet needs a unique IP address, which is provided for identity recognition.

Therefore, when a computer host is connected to the Internet through an Internet service provider (ISP), the ISP allocates an IP address to the computer host each time when connection and registration are performed. If the IP address allocated each time when connection and registration are performed keeps unchanged, the IP address allocation mode is called a stationary IP mode, in which the IP address is exclusive for the computer host, thereby resulting in a high connection cost. In other words, in such a mode, when the computer host is not connected and registered, the IP address becomes idle, and causes the waste of resources. Accordingly, an IP address allocation mode called a floating IP mode becomes available. That is, an IP address allocated each time when connection and registration are performed is not stationary, and the IP address may be allocated to other people when the current computer host is not connected and registered.

However, the floating IP causes troubles when a website is built on a computer host or an IP camera is installed. In detail, the IP address acquired each time after connection and registration is performed is different, so that a corresponding relation between the domain name and the IP address cannot keep unchanged.

### SUMMARY OF THE INVENTION

Accordingly, the present invention is an automatic registration method, which is applicable to a dynamic domain name server (DNS) and a network device. The method comprises the following steps. Account information is input through a user interface provided by the network device. The network device is connected to a corresponding dynamic DNS through Internet according to the account information and is registered. The registered network device continuously updates the IP address automatically for the registered domain name to the dynamic DNS.

The present invention is further a DDNS system, which is applicable to a computer and Internet. The system comprises a network device and a dynamic DNS. The network device is signal-connected to the Internet. The network device comprises a user interface. The computer is used to input account information through the user interface. The network device automatically sends a registration signal according to the account information. The dynamic DNS is signal-connected to the Internet and used for receiving the registration signal to accomplish registration.

According to the above solutions, the network device where the present invention is applied may be an IP camera, a video server, a video receiver, a digital video recorder (DVR), a network DVR (NVR), or a hybrid DVR.

According to the above solutions, the user interface provided by the network device in the present invention generates a web page frame in a browser program executed on a computer, so as to enable a user to type in the account information.

According to the above solutions, the account information in the present invention comprises a hostname, a user name (for example, an E-mail address account of the user), a password, and network notification contact information after successful registration, for example, an account and a password for a real-time network communication software applied beforehand, or an account and a password for a server having a recording function, for example, a file transfer protocol (FTP) server.

According to the above solutions, the web page frame in the present invention comprises a result window for displaying whether a registration result is a success or a failure.

According to the above solutions, the dynamic DNS in the present invention sends an E-mail about successful registration according to the E-mail address account in the account information after the registration is successful. The content of the E-mail comprises the account information and an IP address for being saved by the user. Alternatively, the dynamic DNS sends a successful registration message to notify the user according to other network notification contact information, for example, an account for a real-time communication software such as Live Messenger, Skype, Google Talk, Twitter, Yahoo!Messenger, or ICQ, so that the user keeps or records the account information and the IP address, or stores the record in a designated FTP server.

According to the above solutions, in the present invention, once the user inputs the account information and enables a registration procedure, a DDNS client in the network device uses the account information to register to the dynamic DNS.

According to the above solutions, in the present invention, the registered network device checks whether the current IP address is changed at intervals of a certain constant time period. If the IP address is changed, an IP address update packet is sent to the dynamic DNS, so as to request the dynamic DNS to update the IP address automatically.

According to the above solutions, in the present invention, the IP address of the network device may have two formats IP address, IPv4 and IPv6, at the same time, and the IP address update packet comprises the two formats IP address, IPv4 and IPv6, at the same time.

### BRIEF DESCRIPTION OF THE DRAWINGS

The present invention will become more fully understood from the detailed description given herein below for illustration only, and thus are not limitative of the present invention, and wherein:

FIGS. 1(a) and 1(b) are respectively a schematic block diagram of a function of a preferred embodiment and a flow chart of a method of a preferred embodiment according to the present invention that are developed to eliminate defects of the prior art;

FIG. 2(a) is a schematic block diagram of an internal function of a dynamic DNS according to the present invention;

FIG. 2(b) is a schematic block diagram of an internal function of a network device according to the present invention;

FIG. 3 is a hardware block diagram of a network device; and

FIG. 4 is a schematic view of a web page frame generated in a browser program by a user interface of a network device.

### DETAILED DESCRIPTION OF THE INVENTION

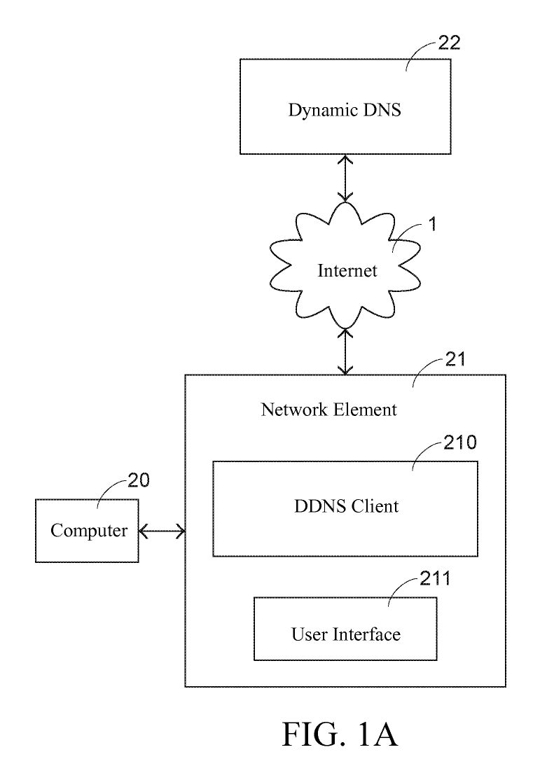

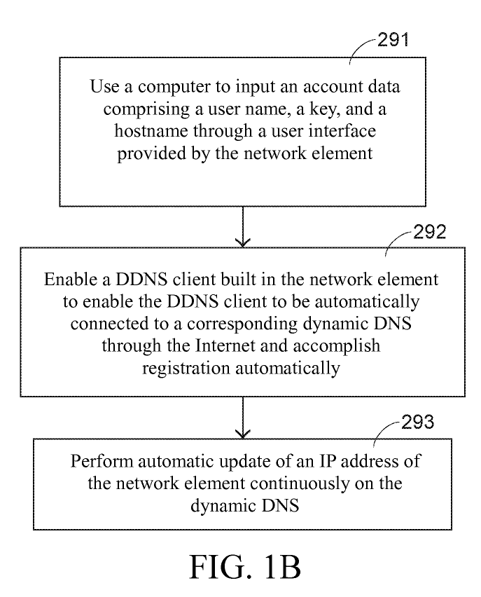

FIGS. 1(a) and 1(b) are respectively a schematic block diagram of a function of a preferred embodiment and a flow chart of a method of a preferred embodiment according to the present invention that are developed to eliminate defects of the prior art. Referring to FIGS. 1(a) and 1(b), in a DDNS system according to the present invention, the user accesses a network device 21 specifically developed in the present invention by using a computer 20 having a keyboard, a mouse, and a display, and inputs account information comprising a user name, a password, and a hostname through a user interface 211 provided by the network device 21 (Step 291). Once the account information is input and stored, a DDNS client 210 built in the network device 21 is enabled. The DDNS client 210 automatically connects to a corresponding dynamic DNS 22 through Internet 1 and sends a registration signal automatically to accomplish registration (Step 292). Subsequently, the automatic update of an IP address of the network device 21 is continuously performed on the dynamic DNS 22 (Step 293). After Step 293 is finished, any user equipment (UE) on the Internet can access the network device 21 using the hostname in the above account information.

Therefore, the network device 21 accomplished through the technical solution of the present invention enables the user to easily finish DDNS setting and start normal operation after inputting the account information only once. Similarly, if the user intends to modify the account information comprising the user name, the password, and the hostname, through accessing the network device 21, the user can achieve the modification via the user interface 211 of the network device 21, so that the defects in the prior art can be effectively eliminated, thereby achieving the main objectives of the present invention. Details of the present invention are further illustrated below.

Besides a common IP camera, the network device 21 where the technical solution of the present invention is applied may also be a video server, a video receiver, a DVR, a NVR, a hybrid DVR, and the like. The processes of account information registration and data modification can be effectively simplified as long as the DDNS client 210 according to the present invention is installed.

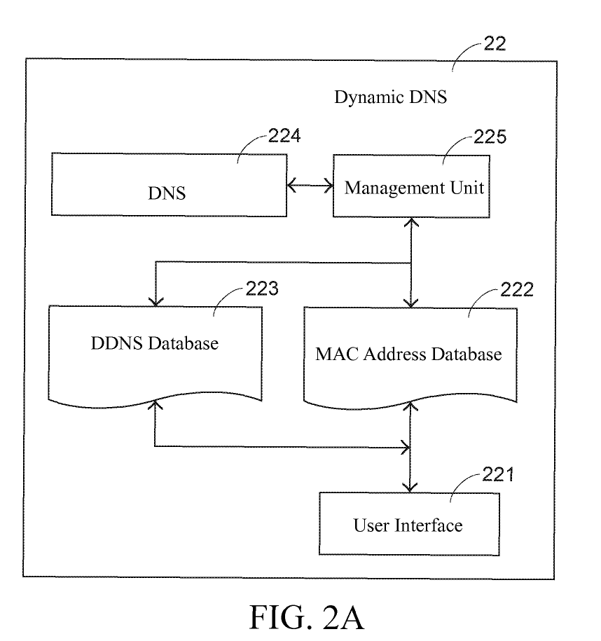

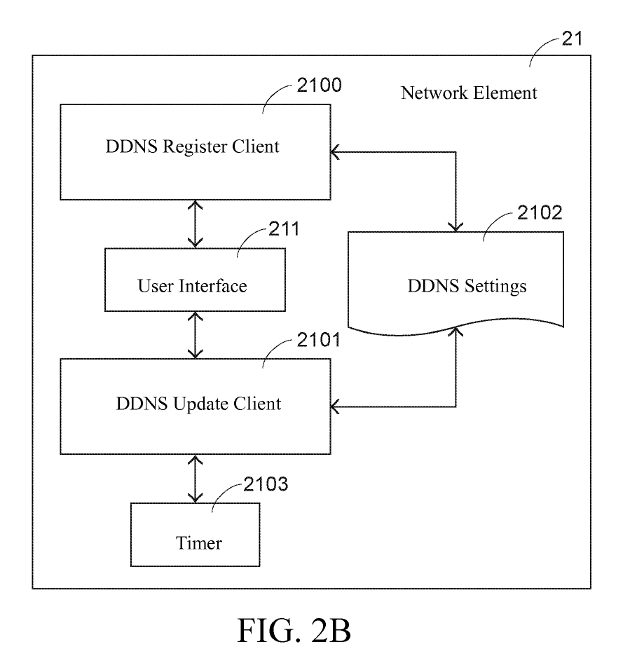

FIG. 2(a) is a schematic block diagram of a function of the dynamic DNS 22 according to the present invention. Referring to FIG. 2(a), a user interface 221 is provided for an administrator to log in a server to perform setting, management, and query. A media access control (MAC) address database 222 is used for storing valid MAC addresses. A DDNS database 223 is used for storing associated data of the user, comprising a MAC address, a user name (for example, an E-mail address account of the user), a password (for example, a password preset by the user), a hostname, an IP address, and the like. A DNS 224 is used for receiving a domain name search request, responding a result, and maintaining a DNS record of each hostname. A management unit 225 is used for receiving a request from a DDNS client and returning a response. The management unit 225 is further used for querying the MAC address database 222 to check whether the MAC address of the client is valid, processing DDNS register and update requests, updating contents of the DDNS database 223, and requesting the DNS 224 to update the DNS record.

FIG. 2(b) is a schematic block diagram of an internal function of the network device 21 according to the present invention. Referring to FIG. 2(b), a DDNS client 210 has a DDNS register client 2100 and a DDNS update client 2101. The DDNS register client 2100 is used for sending an account information comprising a user name, a password, and a hostname to the dynamic DNS 22 to request registration or modification, displaying a response returned from the dynamic DNS 22, and storing DDNS settings 2102 of the successful registration or update. The DDNS update client 2101 is used for updating the IP address periodically. A user interface 211 is provided for the user to perform the registration, modification, and update setting, and comprises a display window for displaying registration or modification results. A timer 2103 is used for counting the time to periodically notify the DDNS update client 2101 to perform update. The DDNS settings 2102 store associated data of the user, which comprises a MAC address, a user name (for example, an E-mail address of the user), a password (for example, a password preset by the user), a hostname, an IP address, and the like, or even comprises other network notification contact information after successful registration, for example, an account and a password for a real-time network communication software applied beforehand, or an account and a password for a server having a recording function, for example, an FTP server.

In addition, the currently used IP address is 32-bit IPv4. However, in the near future, the IP address is bound to evolve to 128-bit IPv6 (Internet Protocol version 6). Therefore, nowadays, some DDNS providers have already provided IPv4 and IPv6 update services. In order to ensure the usage convenience and decrease the traffic of network packets at the same time, the IP address stored in the DDNS database 223 and the DDNS settings 2102 according to the present invention can support both IPv4 and IPv6, and the device according to the present invention can update both IPv4 and IPv6 at the same time by using the same update packet.

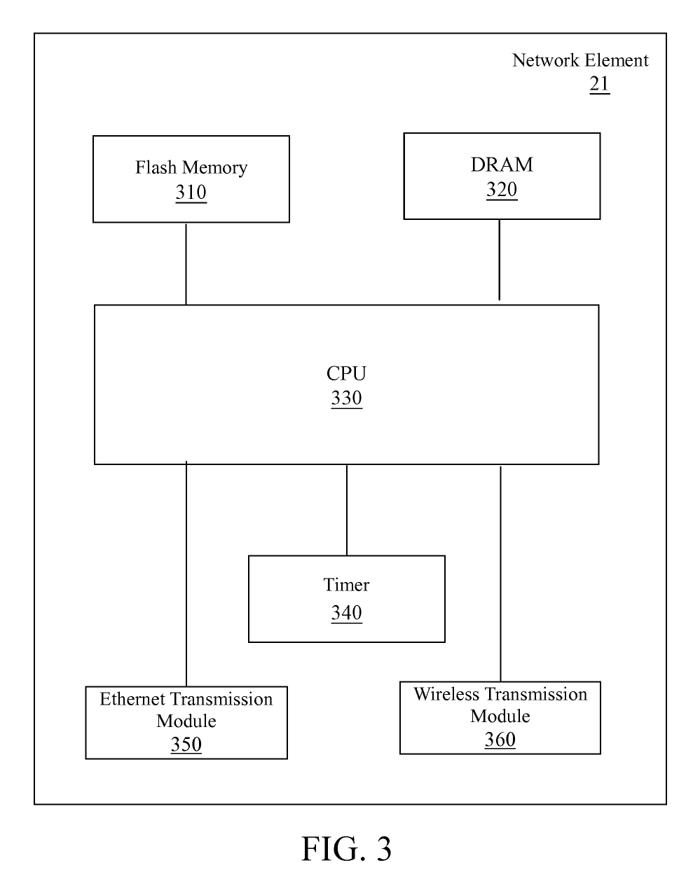

FIG. 3 is a hardware block diagram of a network device. Referring to FIG. 3, the network device 21 comprises a flash memory 310, a dynamic random access memory (DRAM) 320, a central processing unit (CPU) 330, a timer 340, an Ethernet transmission module 350, and a wireless transmission module 360. The flash memory 310, the DRAM 320, the timer 340, the Ethernet transmission module 350, and the wireless transmission module 360 are all electrically connected to the CPU 330. The user may input the DDNS settings 2102 through the Ethernet transmission module 350 or the wireless transmission module 360 and store the DDNS settings 2102 to the flash memory 310. The CPU 330 utilizes the data stored in the flash memory 310 to perform registration for the dynamic DNS 22. Furthermore, the CPU 330 performs update for the dynamic DNS 22 at intervals of a certain time period according to time information of the timer 340.

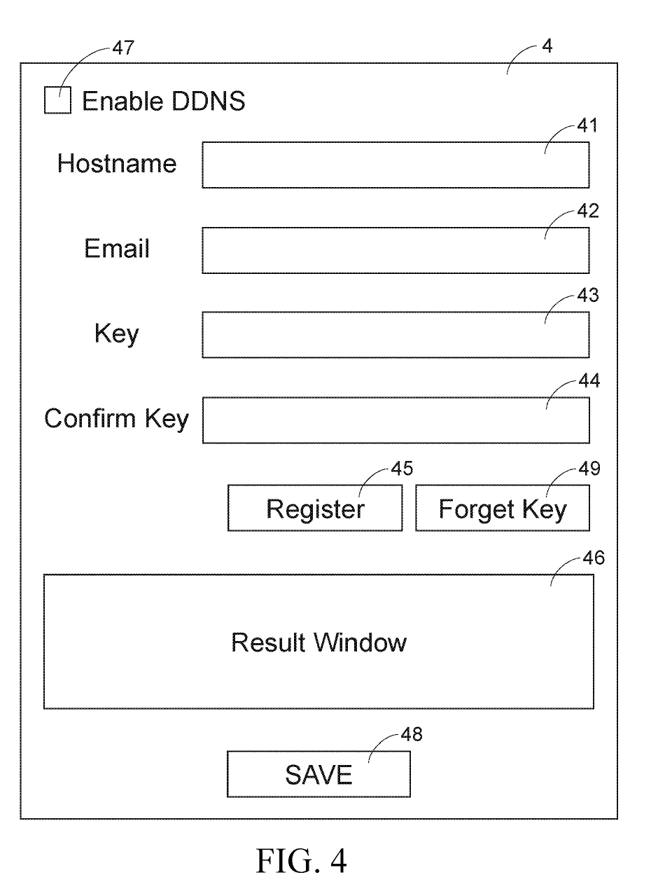

FIG. 4 shows a web page frame 4 generated in a browser program (for example, Internet Explorer or Firefox) by the user interface 211 of the network device 21. Referring to FIG. 4, four fields 41, 42, 43, and 44 are provided for the user to fill a hostname, a user name (for example, an E-mail address of the user), a password (for example, a password preset by the user), and a confirm password. When the user intends to use the DDNS in the network device 21, the user has to register a unique hostname, for example, caml.vivotek.com, for the network device 21. At this time, the user only needs to access the web page frame of the network device 21 through the browser program, fill the four fields 41, 42, 43, and 44, and then click the “Register” button 45. Then, the DDNS register client 2100 uses the account information to register to the dynamic DNS 22. No matter whether the registration is successful or fails, the registration result is displayed in the result window 46. If the registration fails, the user may perform a corresponding operation according to the result. If the result is that the hostname has already been used, the user may input another hostname and then click the “Register” button 45 to register once again. If the registration is successful, the dynamic DNS 22 sends an E-mail about successful registration to the E-mail box of the user, in which all the account information and an IP address are provided, so that the user can save the account information and the IP address. Alternatively, according to other network notification contact information, for example, an account for a real-time communication software such as Live Messenger, Skype, Google Talk, Twitter, Yahoo!Messenger, or ICQ, the dynamic DNS 22 sends a successful registration message to notify the user, so that the user keeps or records the account information and the IP address or stores the record in a designated FTP server.

After the registration is successful, the user only needs to select the option 47 “Enable DDNS” and click the “Save” button 48, so that all the account information is stored in the memory. Subsequently, the timer 2103 starts to count the time. At intervals of a constant time period, the timer 2103 notifies the DDNS update client 2101 to perform an update operation. The DDNS update client 2101 first checks whether the public IP address of the network device 21 is changed. If the public IP address is changed, the DDNS update client 2101 sends an IP address update packet to the dynamic DNS 22 to initiate an IP address update request. If the network device 21 has IP addresses in two formats IPv4 and IPv6, the two IP addresses are both placed in the update request packet. The dynamic DNS 22 that receives the packet updates the IP addresses in IPv4 and IPv6 formats corresponding to the hostname at the same time.

When the user changes an E-mail address or intends to change the registered hostname or password, similarly, the user only needs to access the web page frame (as shown in FIG. 4) of the network device 21 through the browser program, input a new E-mail address or hostname or password, and then click “Register” button 45, so that the DDNS register client 2100 performs the operation of modifying the account information. Similarly, the registration result is displayed in the result window 46. If the registration is successful, the dynamic DNS 22 sends an E-mail about successful registration to the E-mail box of the user, in which all the account information and an IP address are provided, so that the user can save the account information and the IP address. Alternatively, according to the network notification contact information, for example, an account for a real-time communication software such as Live Messenger, Skype, Google Talk, Twitter, Yahoo!Messenger, or ICQ, the dynamic DNS 22 sends successful registration information to notify the user, so that the user keeps or records the account information and the IP address or stores the record in the designated FTP server.

The present invention is directed to the network device 21, so that the MAC address restriction exists. That is, only one hostname can be registered for each network device 21, so as to prevent the DDNS hostname from being abused. However, one situation needs to be considered, that is, for example, when a failure occurs to the original network device 21, the user needs to use another new network device 21, so that the MAC address has to be changed. However, the user intends to continue to use the original hostname. In this case, the user only needs to fill all the correct account information (the hostname, the user name, and the password) in a web page frame of the new network device 21 and performs registration. The dynamic DNS 22 deletes the data of the previous network device 21 from the database and saves the data of the new network device 21 in the database.

In addition, if the user intends to use the original registration information, but forgot the password, the user may fill the hostname and the user name in the web page frame and click the “Forget Password” button 49. Then, the DDNS register client 2100 sends a password query request to the dynamic DNS 22. Similarly, the result is displayed in the result window 46. However, considering the security, once the request is successful, the dynamic DNS 22 turns to send an E-mail comprising the password to the E-mail box of the user, without displaying the password in the result window 46. Alternatively, according to the network notification contact information, for example, an account for a real-time communication software such as Live Messenger, Skype, Google Talk, Twitter, Yahoo!Messenger, or ICQ, the dynamic DNS 22 sends a message carrying the password to notify the user, so that the user keeps or records the password, or stores the record in the designated FTP server.

To sum up, through the DDNS system and the automatic registration method according to the present invention, the user can easily accomplish login and modification operations by inputting the data only once, so as to effectively eliminate the troubles caused by defects in the prior art, thereby achieving the main objectives of the present invention.

What is claimed is:

1. An automatic registration method, applicable to a dynamic domain name server (DNS) and a network device, the method comprising:
inputting account information through a user interface provided by the network device;
connecting the network device to a corresponding dynamic DNS through Internet according to the account information to perform registration; and
performing automatic update of a Internet Protocol (IP) address on the dynamic DNS continuously by the registered network device.

2. The automatic registration method according to claim 1, wherein the user interface provided by the network device generates a web page frame in a browser program executed on a computer, so as to enable a user to type the account information.

3. The automatic registration method according to claim 2, wherein the account information comprises a hostname, a user name, and a password.

4. The automatic registration method according to claim 2, wherein after the registration is successful, the dynamic DNS sends a successful registration message according to network notification contact information in the account information, and the message comprises the account information and an IP address for being saved by the user.

5. The automatic registration method according to claim 1, wherein after a user inputs the account information and enables a registration procedure, a dynamic domain name service (DDNS) client in the network device uses the account information to register to the dynamic DNS.

6. The automatic registration method according to claim 1, wherein the registered network device checks whether an IP address is changed at intervals of a constant time period, and if the IP address is changed, the registered network device sends a IP address update packet to the dynamic DNS, so as to request the dynamic DNS to update the IP address automatically.

7. The automatic registration method according to claim 6, wherein the IP address of the network device comprises two formats IP address, IPv4 and IPv6, at the same time, and the IP address update packet comprises the two formats IP address, IPv4 and IPv6, at the same time.

8. A dynamic domain name service (DDNS) system, applicable to a computer and Internet, the system comprising:
a network device, signal-connected to the Internet, and comprising a user interface, wherein the computer is used to input account information through the user interface, and the network device automatically sends a registration signal according to the account information; and
a dynamic domain name server (DNS), signal-connected to the Internet, for receiving the registration signal to accomplish registration.

9. The DDNS system according to claim 8, wherein the user interface provided by the network device generates a web page frame in a browser program executed on the computer, so as to enable a user to type the account information.

10. The DDNS system according to claim 9, wherein the account information comprises a hostname, a user name, and a password.

11. The DDNS system according to claim 9, wherein after the registration is successful, the dynamic DNS sends a successful registration message according to network notification contact information in the account information, and the message comprises the account information and an Internet Protocol (IP) address for being saved by the user.

12. The DDNS system according to claim 8, wherein after a user inputs the account information and enables a registration procedure, a DDNS client in the network device uses the account information to register to the dynamic DNS.

13. The DDNS system according to claim 8, wherein the registered network device checks whether an IP address is changed at intervals of a constant time period, and if the IP address is changed, the registered network device sends a IP address update packet to the dynamic DNS, so as to request the dynamic DNS to update the IP address automatically.

14. The DDNS system according to claim 8, wherein the IP address of the network device comprises two formats IP address, IPv4 and IPv6, at the same time, and the IP address update packet comprises the two formats IP address, IPv4 and IPv6, at the same time.

15. A network device capable of realizing automatic registration, connected to a computer and a dynamic domain name server (DNS) through Internet, the network device comprising:
a network transmission module, for connecting to the Internet, and receiving an account information;
a flash memory, for storing the account information;
a central processing unit (CPU), electrically connected to the flash memory, for sending a registration signal automatically according to settings; and
a timer, electrically connected to the CPU, for counting time to automatically update a dynamic domain name.

16. The network device capable of realizing automatic registration according to claim 15, wherein a user interface provided by the network device generates a web page frame in a browser program executed on the computer, so as to enable a user to type in the account information.

17. The network device capable of realizing automatic registration according to claim 16, wherein the account information comprises a hostname, a user name, and a password.

18. The network device capable of realizing automatic registration according to claim 15, wherein after the registration is successful, the dynamic DNS sends a successful registration message according to network notification contact information in the account information, and the message comprises the account information and an Internet Protocol (IP) address for being saved by a user.

19. The network device capable of realizing automatic registration according to claim 15, wherein after a user inputs the account information and enables a registration procedure, a dynamic domain name service (DDNS) client in the network device uses the account information to register to the dynamic DNS.

20. The network device capable of realizing automatic registration according to claim 15, wherein the registered network device checks whether an IP address is changed at intervals of a constant time period, and if the IP address is changed, the registered network device sends a IP address update packet to the dynamic DNS, so as to request the dynamic DNS to update the IP address automatically.
